(19) United States
(12) Patent Application Publication
(10) Pub. No.: US 2013/0206306 A1
(43) Pub. Date: Aug. 15, 2013

(54) Crown Reinforcement for Aircraft Tire

(71) Applicants: Vincent Estenne, Clermont-Ferrand Cedex 9 (FR); Laurent Bucher, Clermont-Ferrand Cedex 9 (FR)

(72) Inventors: Vincent Estenne, Clermont-Ferrand Cedex 9 (FR); Laurent Bucher, Clermont-Ferrand Cedex 9 (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/808,704

(22) PCT Filed: Jul. 5, 2011
(86) PCT No.: PCT/EP11/61271

§ 371 Date: Mar. 14, 2013

(30) Foreign Application Priority Data
Jul. 7, 2010 (FR) 1055496

(51) Int. Cl. B60C 9/18; B32B 3/18

(52) U.S. Cl. CPC B60C 9/18; B32B 3/18
USPC 152/526; 428/114

(57) ABSTRACT

An improvement of an airplane tire to obtain a more even distribution of temperature within the crown of the tire. An airplane tire comprises a crown reinforced by a working reinforcement (3), comprising at least one layer of working reinforcement (30) comprising axially juxtaposed substantially circumferential strips (31) comprising mutually parallel textile reinforcing elements (32) coated with a polymer coating material (33). Each strip of at least one layer of working reinforcement is in contact, over at least its radially inner axial face, with a heat transfer element (34) comprising mutually parallel substantially circumferential threadlike elements (35) made of a heat-conducting material with thermal conductivity at least equal to 50 times the thermal conductivity of the polymer coating material. Heat transfer element (34) comprises substantially circumferential threadlike elements (35) that have periodic geometric oscillations parallel to the strip in contact.

The present invention relates to an airplane tire and, in particular, to the crown reinforcement of an airplane tire comprising layers of textile reinforcing elements.

Since a tire has a geometry that exhibits symmetry of revolution about an axis of rotation, the geometry of the tire can be described in a meridian plane containing the axis of rotation of the tire. For a given meridian plane, the radial, axial and circumferential directions respectively denote the directions perpendicular to the axis of rotation of the tire, parallel to the axis of rotation of the tire, and perpendicular to the meridian plane. In what follows, the expressions “radially on the inside” and “radially on the outside” respectively mean “closer to the axis of rotation of the tire in the radial direction” and “further away from the axis of rotation of the tire, in the radial direction”. The expressions “axially on the inside” and “axially on the outside” respectively mean “closer to the equatorial plane, in the axial direction” and “further away from the equatorial plane, in the axial direction”, the equatorial plane being the plane perpendicular to the axis of rotation of the tire and passing through the middle of the tread surface of the tire.

An airplane tire is characterized by a nominal pressure in excess of 9 bar and a nominal level of deflection greater than or equal to 32%. The nominal pressure is the nominal inflation pressure of the tire as defined, for example, by the standards laid down by the Tire and Rim Association or TRA. The nominal level of deflection of a tire is, by definition, its radial deformation, or variation in radial height, when it changes from an unladen inflated state to a statically loaded inflated state under nominal load and pressure conditions as defined, for example, by the TRA standard. It is expressed in the form of a relative deflection, defined by the ratio of this variation in radial height of the tire to half the difference between the outside diameter of the tire and the maximum diameter of the rim measured on the rim flange. The outside diameter of the tire is measured under static conditions in an unladen state inflated to the nominal pressure.

A tire in general comprises a crown comprising a tread intended to come into contact with the ground via a tread surface, two beads intended to come into contact with a rim and two sidewalls connecting the crown to the beads. A radial tire, such as is generally used on an airplane, more specifically comprises a radial carcass reinforcement and a crown reinforcement both as described, for example, in document EP1381525.

The radial carcass reinforcement is the tire reinforcing structure that connects the two beads of the tire. The radial carcass reinforcement of an airplane tire generally comprises at least one layer of carcass reinforcement, each layer of carcass reinforcement being made up of mutually parallel reinforcing elements, usually textile, making an angle of between 80° and 100° with the circumferential direction.

The crown reinforcement is the tire reinforcing structure radially on the inside of the tread and at least partially radially on the outside of the radial carcass reinforcement. The crown reinforcement of an airplane tire generally comprises at least one layer of crown reinforcement, each layer of crown reinforcement being made up of mutually parallel reinforcing elements coated in a polymer coating material. Within the layers of crown reinforcement, a distinction is made between the layers of working reinforcement that make up the working reinforcement, usually made up of textile reinforcing elements, and the layers of protective reinforcement that make up the protective reinforcement and are made of metallic or textile reinforcing elements positioned radially on the outside of the working reinforcement.

During the manufacture of an airplane tire, a layer of working reinforcement is usually created by a zigzag winding or winding in turns of strips made up of textile reinforcing elements, around a cylindrical manufacturing device by performing an axial translational movement of the strip for each turn of winding so as to obtain the expected axial width of layer working reinforcement. The layer of working reinforcement is thus made up of axially juxtaposed strips. What is meant by zigzag winding is a winding in a curve formed of undulations that are periodic, either over half a period per turn of winding or over one period per turn of winding, the angle of the textile reinforcing elements of the strips generally being comprised between 8° and 30° with respect to the circumferential direction. For a layer of working reinforcement that is created by winding in turns, the angle of the textile reinforcing elements of the strips is generally comprised between 0° and 8° with respect to the circumferential direction. Whatever the type of winding of the strips, the angle of the textile reinforcing elements of the strips is therefore generally less than 30° with respect to the circumferential direction. For this reason, the strips and the resulting working layer are said to be substantially circumferential, which means substantially circumferential in direction with undulations of limited amplitude about the circumferential direction.

The reinforcing elements of the layers of working reinforcement are mutually parallel, which means to say that the distance between the geometric curves of two adjacent reinforcing elements is constant, it being possible for the geometric curves to exhibit periodic undulations.

The reinforcing elements of the layers of carcass reinforcement and of the layers of working reinforcement, for airplane tires, are usually cords made up of spun yarns of textile filaments, preferably made of aliphatic polyamides or aromatic polyamides.

The reinforcing elements of the layers of protective reinforcement may be either cords made up of metallic threads, or cords made up of spun yarns of textile filaments.

The mechanical properties under tension (modulus, elongation and force on rupture) of the textile reinforcing elements are measured after prior conditioning. What is meant by “prior conditioning” is that the textile reinforcing elements are stored for at least 24 hours, prior to measuring, in a standard atmosphere in accordance with European standard DIN EN 20139 (a temperature of 20±2° C.; a relative humidity of 65±2%). The measurements are taken in a known way using a tensile test machine made by ZWICK GmbH & Co (Germany) of type 1435 or type 1445. The textile reinforcing elements are subjected to tension on an initial length of 400 mm at a nominal rate of 200 mm/min. All the results are averaged over 10 measurements.

A polymer material, such as the polymer coating material used for the textile reinforcing elements of the layers of working reinforcement is mechanically characterized, after curing, by tensile stress—strain properties that are determined by tensile testing. This tensile testing is performed, on a test specimen, using a method known to those skilled in the art, for example in accordance with International Standard ISO 37, and under normal temperature (23+ or −2° C.) and humidity (50+ or −5% relative humidity) conditions defined by International Standard ISO 471. For a polymer mixture, the tensile stress measured for a 10% elongation of the test specimen is known as the elasticity modulus at 10% elongation and is expressed in megapascals (MPa).

In use, the mechanical stresses of running, resulting from the combined action of the nominal pressure, of the load applied to the tire which may vary between 0 and 2 times the nominal load, and of the speed of the airplane, introduce tension cycles into the reinforcing elements of the layers of working reinforcement.

These tension cycles generate, within the polymer coating material of the reinforcing elements of the layers of working reinforcement, sources of heat, particularly at the axial ends of the layers of working reinforcement. These sources of heat are localized hot spots where the removal of heat is difficult, because the heat has to be able to spread either through the polymer coating material or through the textile reinforcing elements. However, the polymer coating material, because of its low thermal conductivity, is a poor conductor of heat. Likewise, the textile reinforcing elements, because of their low thermal conductivity, cannot make an effective contribution towards the removal of heat. This results in excessive heating of the polymer coating material, which is prejudicial to its correct mechanical integrity and is likely to cause it to degrade, thus leading to premature tire failure.

Various technical solutions have been conceived of in an attempt to create a path for the removal of the heat generated in the working reinforcement. Documents EP1031441 and JP2007131282 disclose thermally conducting polymer materials with improved thermal conductivity. Document EP1548057 proposes polymer materials that include carbon nanotubes to increase the thermal conductivity. Document EP1483122 describes a thermal drain, in the form of metallic cables laid in a meridian plane and inserted at the end of the working reinforcement. Finally, document KR812810 proposes a thermally conducting insert, which may be metallic and is arranged at the end of the working reinforcement.

The inventors have set themselves the goal of improving the removal of the heat generated in the working reinforcement of an airplane tire, from the hottest points, which are generally located at the ends of the layers of working reinforcement, to the points that are the least hot, generally located in the central region of the working reinforcement, so as to obtain a more even temperature distribution across the crown of the tire, while at the same time minimizing the impact this has on the loadings of the working reinforcement.

This objective has been achieved, according to the invention, using an airplane tire comprising:
a crown intended to come into contact with the ground via a tread and connected by two sidewalls to two beads intended to come into contact with a rim,
a radial carcass reinforcement connecting the two beads,
a crown reinforcement, radially on the inside of the tread and radially on the outside of the radial carcass reinforcement, comprising a working reinforcement and a protective reinforcement,
the working reinforcement, radially on the inside of the protective reinforcement, comprising at least one layer of working reinforcement,
each layer of working reinforcement consisting of axially juxtaposed substantially circumferential strips,
each strip being made up of mutually parallel textile reinforcing elements coated with a polymer coating material,
each strip of at least one layer of working reinforcement being in contact, over at least its radially inner axial face, with a heat transfer element comprising mutually parallel substantially circumferential threadlike elements made of a heat-conducting material,
the thermal conductivity of the heat-conducting material of a substantially circumferential threadlike element being at least equal to 50 times the thermal conductivity of the polymer coating material of the textile reinforcing elements of the strip in contact with the heat transfer element,
and a heat transfer element comprising substantially circumferential threadlike elements that have periodic geometric oscillations parallel to the strip in contact.

According to the invention, each strip of at least one layer of working reinforcement is advantageously in contact with a heat transfer element, over at least its radially inner axial face, which means that face of the strip that is parallel to the axis of rotation of the tire and radially closest to the axis of rotation of the tire.

A heat transfer element comprises threadlike elements that are substantially circumferential, which means to say that the angle of the threadlike elements, which may be circumferentially variable, is less than 30° with respect to the circumferential direction. The threadlike elements are mutually parallel, which means to say that the distance between the geometric curves of two adjacent threadlike elements is constant, it being possible for the geometric curves to display periodic undulations.

The threadlike elements are made up of a heat-conducting material. What is meant by a heat-conducting material that makes up a threadlike element is a material the thermal conductivity of which is high, such as, for example, a metallic material. The thermal conductivity of a material is a physical quantity, expressed in W.m⁻¹.K⁻¹, that characterizes the ability of a material to carry heat energy. The higher the thermal conductivity of a heat-conducting material, the better it is at transporting heat energy.

By contrast, a material that is not a conductor of heat or, more precisely, that is a poor conductor of heat, means a material the thermal conductivity of which is low, for example such as a conventional polymer material conventionally used in a tire.

The heat or heat energy generated at an axial end of the layer of working reinforcement is removed by the heat transfer element in contact with the strip situated at the axial end of the layer of working reinforcement. This end heat transfer element, made up of substantially circumferential threadlike elements will, on the one hand, distribute over the circumference of the layer some of the heat energy removed via its substantially circumferential threadlike elements and, on the other hand, transmit another portion of the heat energy removed axially inwards to the next heat transfer element. The heat is thus removed, little by little, both circumferentially and axially.

The heat transfer in the circumferential direction is effective because it is performed by the substantially circumferential threadlike elements that are made up of a heat-conducting material.

By contrast, the heat transfer in the axial direction would seem a priori to be less effective than the heat transfer in the circumferential direction because there is no continuously conductive material in the axial direction. However, this disadvantage is compensated for either by the zigzag lay which establishes conductive continuity between the ends of the layer of working reinforcement or by the spiral lay which provides axial heat transfer from turn to turn.

This heat transfer, the purpose of which is to even out the temperatures between the axial ends and the centre of the layer of working reinforcement is possible because the temperatures are higher between the axial ends and the centre of the layer of working reinforcement, hence creating a temperature gradient that drives the conduction of heat.

In order for the heat energy to be removed for preference by the substantially circumferential threadlike elements of the heat transfer elements in contact with the strips that make up a layer of working reinforcement, the thermal conductivity of any heat-conducting material of a substantially circumferential threadlike element needs to be significantly higher than that of the polymer coating material with which the textile reinforcing elements of the strip in contact with the heat transfer element are coated, the polymer coating material being, by nature, a poor conductor of heat. The inventors have demonstrated that a thermal conductivity of a heat-conducting material that is at least equal to 50 times that of the polymer coating material that coats the textile reinforcing elements of the strip in contact with the heat transfer element would allow a sufficient amount of heat energy to be removed that the level of heat at the axial end of the layer of working reinforcement can be reduced to an acceptable level, i.e. a level that is not likely to degrade the materials concerned.

Still according to the invention, a heat transfer element comprises substantially circumferential threadlike elements that exhibit periodic geometric oscillations parallel to the strip in contact.

Indeed it is advantageous for the substantially circumferential threadlike elements of a heat transfer element to exhibit periodic geometric oscillations parallel to the strip in contact, i.e. about the radial direction. These periodic geometrical oscillations may, non-exhaustively, be alternating V-shaped folds or undulations in a sinusoidal shape. The presence of periodic geometrical oscillations increases the circumferential extensibility of the heat transfer element and, therefore, reduces the risk of a tensile rupture of the heat transfer element.

Advantageously, the ratio between the peak-to-peak amplitude of the periodic geometric oscillations and the wavelength of the period is greater than 0.05 in order to give the heat transfer element satisfactory circumferential extensibility.

Advantageously, each strip of each layer of working reinforcement is in contact, over at least its radially inner axial face, with a heat transfer element comprising mutually parallel substantially circumferential threadlike elements made of a heat-conducting material. The heat generated at the axial ends of each of the layers of working reinforcement, and not only the heat generated at the axial ends that have the highest temperatures, is advantageously removed so as to even out the temperatures in each layer of working reinforcement and therefore throughout the thickness of the radial reinforcement.

Advantageously also, a heat transfer element is made up of at least one substantially circumferential band. A substantially circumferential band of heat transfer element is an element that extends around the entire periphery of the tire while remaining in contact with a strip of layer of working reinforcement. The meridian section of a substantially circumferential band is a rectangle, the shortest dimension of which is directed radially and the longest dimension of which is directed axially. A substantially circumferential band follows the substantially circumferential path of the strip with which it is in contact.

A first preferred embodiment is to have a heat transfer element made up of a single substantially circumferential band of which the axial width is equal to the axial width of the strip in contact with the heat transfer element. Such an embodiment in which the axial width of the single substantially circumferential band is equal to the axial width of the strip is advantageous in terms of the manufacture of the tire because the strip and the single substantially circumferential band can be assembled beforehand at the elementary level of the strip, then the assembly thus created of the strip and of the single substantially circumferential band can be wound onto the cylindrical device used to create the layer of working reinforcement. Further, the continuity of the conduction of heat in the circumferential and axial directions is afforded by the continuity of each single substantially circumferential metallic band and by the spiroidal or zigzag circumferential winding of the strip. Thus, this embodiment allows optimal removal of the heat generated at the ends of the layer of working reinforcement both in the axial direction and in the circumferential direction.

According to a second embodiment of the invention, a heat transfer element is made up of a plurality of axially juxtaposed substantially circumferential bands, of which the axial width, which is the sum of the axial widths of the elementary substantially circumferential bands is equal to the axial width of the strip in contact with the heat transfer element. This second embodiment is an alternative form of manufacture of the first embodiment with a single substantially circumferential band.

A third embodiment of the invention is characterized by a heat transfer element made up of a plurality of axially disjointed substantially circumferential bands, distributed over the axial width of the strip in contact with the heat transfer element. In this embodiment, a heat transfer element is thus made up of a plurality of substantially circumferential bands disjointed one from the next in pairs in the axial direction: this means that the sum of the axial widths of the substantially circumferential bands is less than the axial width of the strip with which the substantially circumferential bands are in contact. Because of this geometric discontinuity between the substantially circumferential bands, the conduction of heat is not performed continuously in the axial direction but is afforded continuously in the circumferential direction. However, such an embodiment makes it possible for the heat transfer element, made up of disjointed substantially circumferential bands, to have rigidities which are lower than those of a heat transfer element made up of a single substantially circumferential band. As in the second embodiment, the flexural rigidity in a radial direction of a plurality of substantially circumferential bands which are disjointed one from the next in pairs is lower than the flexural rigidity in a radial direction of a single substantially circumferential band. In addition, the circumferential tensile rigidity of the heat transfer element in this embodiment makes only a small contribution to the circumferential tensile rigidity of the assembly of the strip and of the heat transfer element and this makes for easier winding of the assembly of the strip and of the heat transfer element around the cylindrical device when the layer of working reinforcement is being manufactured.

A heat transfer element advantageously comprises a polymer coating material for coating the substantially circumferential threadlike elements, for the sake of ease of manufacture and mechanical integrity of the heat transfer element, and its assembly with the strip with which it is in contact.

According to the invention, any substantially circumferential threadlike element of a heat transfer element is a cord made up of an assembly of elementary threads, industrial manufacture of which has been mastered.

According to another feature of the invention, any substantially circumferential threadlike element of a heat transfer element is a metallic cord, a metal being by nature a significantly better conductor of heat than the polymer coating material contained in a strip of layer of working reinforcement. By way of example, a metallic material, such as, for example, aluminum, has a thermal conductivity of 200 W.m⁻¹.K⁻¹, whereas a polymer material has a thermal conductivity of 0.3 W.m⁻¹.K⁻¹.

For preference, any substantially circumferential threadlike element of a heat transfer element is an aluminum cord. Aluminum requires an interface coating to cause it to adhere to the polymer coating material of the strip in contact; there are various techniques available for achieving this: a coating of the brass type, of organic type (silane or amino-silane), epoxy or commercial adhesives.

Advantageously, any substantially circumferential threadlike element of a heat transfer element has a diameter at most equal to 0.9 mm. This cross section has to be large enough to perform the function of removing the heat but also has to be limited in order to limit the contribution that the heat transfer element makes towards the circumferential tensile rigidity of the assembly of the strip and of the heat transfer element.

Advantageously, any substantially circumferential threadlike element of a heat transfer element has a diameter at least equal to 0.1 mm, in order to guarantee industrial feasibility.

The number of substantially circumferential threadlike elements is comprised between 1 and 10 per cm of width of band, to guarantee the removal, in the circumferential direction, of a sufficient amount of heat energy generated at the end of a layer of working reinforcement.

The sum of the cross sections of the substantially circumferential threadlike elements per cm of width of band needs to be below 0.5 mm², so as to limit the contribution that the heat transfer element makes towards the overall circumferential tensile rigidity of the assembly of the strip and of the heat transfer element.

The circumferential load per unit axial width, or distributed tension, of a heat transfer element is at most equal to 0.3 times the circumferential load per unit axial width of the strip in contact with the heat transfer element, which makes it possible to limit the contribution that the heat transfer element makes towards the overall circumferential tensile rigidity of the assembly of the strip and of the heat transfer element.

A heat transfer element advantageously comprises substantially circumferential threadlike elements that have periodic geometric oscillations in a circumferential plane perpendicular to the axial direction. These periodic geometric oscillations may, non-exhaustively, be alternating V-shaped bends or undulations of sinusoidal shape. The presence of periodic geometric oscillations increases the circumferential extensibility of the heat transfer element and therefore reduces the risk of a tensile rupture of the heat transfer element.

Advantageously, the ratio between the peak-to-peak amplitude of the periodic geometric oscillations and the wavelength of the period is greater than 0.05 in order to give the heat transfer element satisfactory circumferential extensibility.

Another subject of the invention is a metalized strip, comprising
a strip made up of mutually parallel textile reinforcing elements coated in a polymer coating material,
the strip being in contact, over at least its radially inner axial face, with a heat transfer element comprising at least one heat-conducting material,
the thermal conductivity of a heat-conducting material of a heat transfer element being at least equal to 50 times the thermal conductivity of the polymer coating material of the textile reinforcing elements of the strip in contact with the heat transfer element,
and a heat transfer element comprising substantially circumferential threadlike elements has periodic geometric oscillations parallel to the strip in contact.

The invention also relates to the use of a metalized strip as described hereinabove in a tire according to the invention.

Another subject of the invention is a metalized strip exhibiting all the abovementioned features for the tire according to the invention.

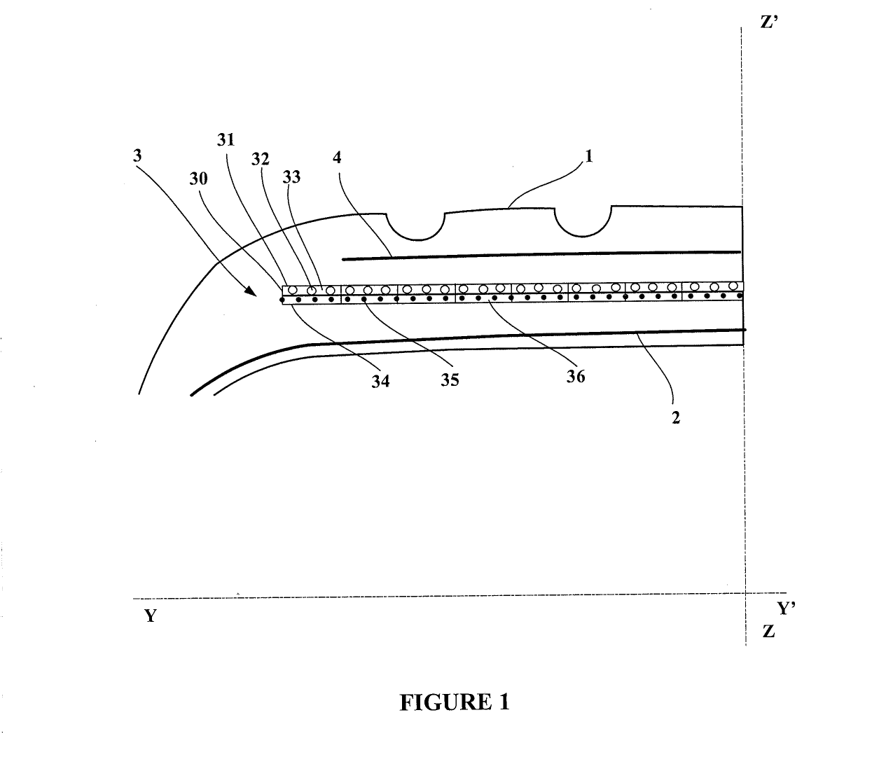

The features and other advantages of the invention will be better understood with the aid of attached FIGS. 1 to 4b:

FIG. 1 has a meridian cross section of a tire crown according to the invention, in particular schematically depicting the strips of a layer of working reinforcement and the corresponding substantially circumferential bands of the heat transfer element.

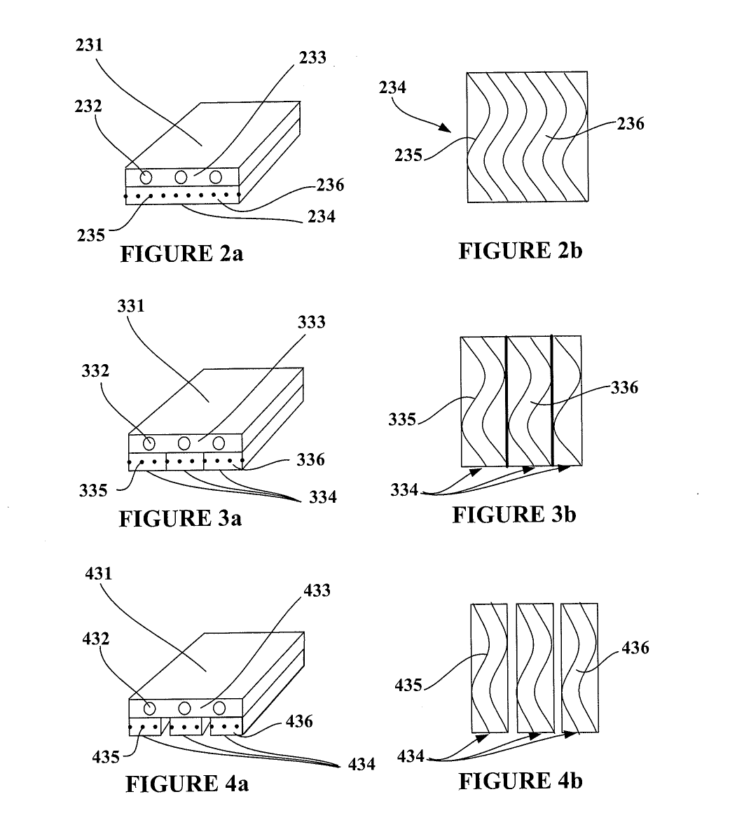

FIG. 2a is a diagram of the assembly of a strip of layer of working reinforcement and of a heat transfer element according to a first embodiment of the invention.

FIG. 2b is a plan view of a heat transfer element according to a first embodiment of the invention.

FIG. 3a is a diagram of the assembly of a strip of layer of working reinforcement and of a heat transfer element according to a second embodiment of the invention.

FIG. 3b is a plan view of a heat transfer element according to a second embodiment of the invention.

FIG. 4a is a diagram of the assembly of a strip of layer of working reinforcement and of a heat transfer element according to a third embodiment of the invention.

FIG. 4b is a plan view of a heat transfer element according to a third embodiment of the invention.

In order to make the invention easier to understand, FIGS. 1 to 4b have not been drawn to scale.

FIG. 1 shows a meridian cross section, which means a cross section in a meridian plane, of the crown of a tire according to the invention. It depicts a crown intended to come into contact with the ground via a tread 1, the radial carcass reinforcement 2, the crown reinforcement, radially on the inside of the tread and radially on the outside of the radial carcass reinforcement, comprising a working reinforcement 3 and a protective reinforcement 4. The working reinforcement 3, made up of a superposition of layers of working reinforcement, is not depicted in full: just one layer of working reinforcement 30 has been depicted in order to make the invention easier to understand. The layer of working reinforcement is made up of axially juxtaposed substantially circumferential strips 31. Each strip is made up of mutually parallel textile reinforcing elements 32 coated with a polymer coating material 33. Each strip is in contact, on its radially inner axial face, with a heat transfer element 34, which are made up of substantially circumferential threadlike elements 35 and of a polymer coating material 36.

FIG. 2a is a diagram of the assembly of a strip 231 of layer of working reinforcement and of a heat transfer element 234, according to a first embodiment of the invention. The strip 231, made up of mutually parallel textile reinforcing elements 232 coated with a polymer coating material 233, is in contact, on its radially inner axial face, with a heat transfer element 234 which are made up of substantially circumferential threadlike elements 235 and of a polymer coating material 236. The heat transfer element 234 is made of a single substantially circumferential band of which the axial width is equal to the axial width of the strip 231 in contact.

FIG. 2b is a plan view of a heat transfer element according to a first embodiment of the invention, made up of a single substantially circumferential band 234 of which the axial width is equal to the axial width of the strip 231 in contact with the two-dimensional heat-transfer network. The single substantially circumferential band 234 is made up of substantially circumferential threadlike elements 235 and of a polymer coating material 236.

FIG. 3a is a diagram of the assembly of a strip 331 of layer of working reinforcement and of a heat transfer element 334, according to a second embodiment of the invention. The strip 331, made up of mutually parallel textile reinforcing elements 332 coated with a polymer coating material 333 is in contact, over its radially inner axial face, with a heat transfer element 334, which are made up of substantially circumferential threadlike elements 335 and of a polymer coating material 336. The heat transfer element 334 is made up of a plurality of axially juxtaposed substantially circumferential bands of which the total axial width, which is the sum of the axial widths of each of the substantially circumferential bands, is equal to the axial width of the strip 331 in contact.

FIG. 3b is a plan view of a heat transfer element according to a second embodiment of the invention, made up of a plurality of axially juxtaposed substantially circumferential bands 334 of which the axial width is equal to the axial width of the strip 331 in contact with the heat transfer element. The axially juxtaposed substantially circumferential bands 334 are made up of substantially circumferential threadlike elements 335 and of a polymer coating material 336.

FIG. 4a is a diagram of the assembly of a strip 431 of layer of working reinforcement and of a heat transfer element 434 according to a third embodiment of the invention. The strip, made up of mutually parallel textile reinforcing elements 432 coated with a polymer coating material 433 is in contact, over its radially inner axial face, with a heat transfer element 434 which are made up of substantially circumferential threadlike elements 435 and of a polymer coating material 436. The heat transfer element 434 is made up of a plurality of axially disjointed substantially circumferential bands distributed over the axial width of the strip 431 in contact.

FIG. 4b is a plan view of a heat transfer element according to a third embodiment of the invention, made up of a plurality of axially disjointed substantially circumferential bands 434 distributed over the axial width of the strip 431 in contact with the heat transfer element. The axially disjointed substantially circumferential bands 434 are made up of substantially circumferential threadlike elements 435 and of a polymer coating material 436.

The inventors carried out the invention according to the first embodiment thereof for an aircraft tire of size 46×17R20, the use of which is characterized by a nominal pressure of 15.9 bar, a nominal static load of 20473 daN and a maximum reference speed of 225 km/h. The working crown reinforcement of this tire comprises 9 layers of working reinforcement, which are made up of substantially circumferential strips, three of them being laid in turns which are juxtaposed in the axial direction, and 6 of them being wound in a zigzag, with one period per turn of winding, the maximum angle of the textile reinforcing elements of the strips being equal to 11° with respect to the circumferential direction. Each strip is made up of reinforcing elements of hybrid type, i.e. made up of a combination of spun yarns of filaments of aromatic polyamides and spun yarns of filaments of aliphatic polyamides, coated with a polymer coating material the thermal conductivity of which is equal to 0.3 W.m⁻¹.K⁻¹. Each strip is in contact, on its radially inner face, with a heat transfer element made up of a single substantially circumferential band, itself made up of threadlike elements of the aluminum cord type with a thermal conductivity of 237 W.m⁻¹.K⁻¹. These substantially circumferential threadlike elements, with a diameter at most equal to 0.9 mm, are distributed in a substantially circumferential direction. The sum of the cross sections of the substantially circumferential threadlike elements per cm of width of band needs to be less than 0.5 mm².

The inventors used finite-element numerical simulation on a tire running steadily at a speed of 10 km/h, under a nominal static load of 20.5 tonnes and a nominal pressure of 15.9 bar to demonstrate that the difference in temperatures between the axial end and the central part, in the vicinity of the equatorial plane, of the most heavily thermally loaded layer of working reinforcement drops from 90.5° C. to 78.5° C. when moving from the reference tire, which has strips with no heat transfer element, to the tire according to the invention. In the example chosen, the invention thus allows a 12° C. reduction in the maximum temperature at the end of the crown reinforcement.

The invention can also be extended to other embodiments such as, for example and non-exhaustively, a heat transfer element comprising two superposed layers, each layer comprising mutually parallel substantially circumferential threadlike elements exhibiting periodic geometric oscillations parallel to the strip in contact, the periodic geometric oscillations being phase-shifted between the two layers so as to form a two-dimensional network.

1. An airplane tire comprising:
a crown adapted to come into contact with the ground via a tread and connected by two sidewalls to two beads intended to come into contact with a rim;
a radial carcass reinforcement connecting the two beads;
a crown reinforcement, radially on the inside of the tread and radially on the outside of the radial carcass reinforcement, comprising a working reinforcement and a protective reinforcement;
the working reinforcement, radially on the inside of the protective reinforcement, comprising at least one layer of working reinforcement;
each layer of working reinforcement comprising axially juxtaposed substantially circumferential strips;
each strip being comprised of mutually parallel textile reinforcing elements coated with a polymer coating material;
wherein each strip of at least one layer of working reinforcement is in contact, over at least its radially inner axial face, with a heat transfer element comprising mutually parallel substantially circumferential threadlike elements made of a heat-conducting material, wherein the thermal conductivity of the heat-conducting material of a substantially circumferential threadlike element is at least equal to 50 times the thermal conductivity of the polymer coating material of the textile reinforcing elements of the strip in contact with the heat transfer element, and wherein a heat transfer element comprises substantially circumferential threadlike elements that have periodic geometric oscillations parallel to the strip in contact.

2. The tire according to claim 1, wherein each strip of each layer of working reinforcement is in contact, over at least its radially inner axial face, with a heat transfer element comprising mutually parallel substantially circumferential threadlike elements made of a heat-conducting material.

3. The tire according to claim 1, wherein a heat transfer element is comprised of at least one substantially circumferential band.

4. The tire according to claim 1, wherein a heat transfer element is comprised of a single substantially circumferential band of which the axial width is equal to the axial width of the strip in contact with the heat transfer element.

5. The tire according to claim 1, wherein a heat transfer element is comprised of a plurality of axially juxtaposed substantially circumferential bands, of which the sum of the axial widths is at most equal to the axial width of the strip in contact with the heat transfer element.

6. The tire according to claim 1, wherein a heat transfer element is comprised of a plurality of axially disjointed substantially circumferential bands of which the sum of the axial widths is at most equal to the axial width of the strip in contact with the heat transfer element.

7. The tire according to claim 1, wherein a heat transfer element comprises a polymer coating material for coating the substantially circumferential threadlike elements.

8. The tire according to claim 1, wherein any substantially circumferential threadlike element, of a heat transfer element is a cord.

9. The tire according to claim 1, wherein any substantially circumferential threadlike element of a heat transfer element is a metallic cord.

10. The tire according to claim 1, wherein any substantially circumferential threadlike element of a heat transfer element is an aluminum cord.

11. The tire according to claim 9, wherein any substantially circumferential threadlike element of a heat transfer element has a diameter at most equal to 0.9 mm and at least equal to 0.1 mm.

12. The tire according to claim 9, wherein the number of substantially circumferential threadlike elements is comprised between 1 and 10 per cm of width of band.

13. The tire according to claim 9, wherein the sum of the cross sections of the substantially circumferential threadlike elements per cm of width of band needs to be below 0.5 mm².

14. The tire according to claim 1, wherein the circumferential load per unit axial width, or distributed tension, of a heat transfer element is at most equal to 0.3 times the circumferential load per unit axial width of the strip in contact with the heat transfer element.

15. The tire according to claim 1, wherein a heat transfer element comprises substantially circumferential threadlike elements that have periodic geometric oscillations in a circumferential plane perpendicular to the axial direction.

16. A metalized strip, comprising a strip made up comprised of mutually parallel textile reinforcing elements coated in a polymer coating material wherein the strip is in contact, over at least its radially inner axial face, with a heat transfer element comprising at least one heat-conducting material, wherein the thermal conductivity of a heat-conducting material of a heat transfer element is at least equal to 50 times the thermal conductivity of the polymer coating material of the textile reinforcing elements of the strip in contact with the heat transfer element, and wherein a heat transfer element comprises substantially circumferential threadlike elements has periodic geometric oscillations parallel to the strip in contact.
